(19) United States
(12) Patent Application Publication
(10) Pub. No.: US 2010/0147095 A1
(43) Pub. Date: Jun. 17, 2010

(54) CONTROL ELEMENT FOR A MOTOR VEHICLE

(75) Inventors: Gerold Eckert, Bad Neustadt (DE); Thilo Kirchner, Burkardroth (DE)

Correspondence Address: CANTOR COLBURN, LLP, 20 Church Street, 22nd Floor, Hartford, CT, 06103, US

(73) Assignee: PREH GMBH, Bad Neustadt a.d Saale (DE)

(21) Appl. No.: 12/531,592

(22) PCT Filed: Mar. 17, 2008
(86) PCT No.: PCT/EP2008/002114

§ 371 Date: Dec. 14, 2009

(30) Foreign Application Priority Data
Mar. 17, 2007 (DE) 10 2007 012 863.2

(51) Int. Cl. G05G 9/047

(52) U.S. Cl. 74/471 R

(57) ABSTRACT

A control element for a motor vehicle, includes a control button retained in the control element so as to be at least rotatable and pressable, where a switching and/or regulating function is assigned to every movement, where the control element can additionally be shifted and where the shifting movement takes place in a plane horizontal relative to the control button.

### TECHNICAL FIELD

The invention relates to a control element for a motor vehicle, comprising a control button retained in the control element so as to be at least rotatable and pressable, wherein a switching and/or regulating function is assigned to every movement.

### BACKGROUND

In areas in which a large number of controlling options and/or selecting options and/or selection menus are available, it is customary that control elements are used which enable a plurality of switching and/or regulating functions in only a single control element. Such central control units or multifunctional input elements are often used in motor vehicles. In this case, it is then possible to make a selection from a menu and at the same time opt for a selective choice and confirm it by means of the various control functions. For this purpose, these control elements are provided with a rotating, pressing and tilting function, wherein each individual function initializes or selects a switching and/or regulating function. In particular, such control elements are known in which a rotatable and pressable control button is provided, and which comprises an additional joystick-like input button located in the central axis of the control element. In this case, the integrated joystick-like input button can be moved into any direction and this arbitrary direction can be detected and evaluated, for the most part, by means of an optoelectric evaluation system. Such control elements are known and are mostly used in central armrests or center consoles of motor vehicles in combination with indicators, screens and/or displays.

One drawback of such control elements provided with joystick-like input elements is that the operability of the joystick-like input elements is limited because they are installed in the rotary button, so that an actuation is very difficult for the operator to detect by touch. Moreover, the integrated joystick-like input elements entail very tall constructional designs of the components, because the tilting movements always take place over only very small angles. This in turn has an adverse effect on the production costs.

### BRIEF SUMMARY

The disclosure provides a control element which, in addition to the function of being rotatable and pressable, is also additionally shiftable, wherein the shifting movement takes place in a plane horizontal relative to the control button. The construction according to the invention of the control element now creates the option of providing a control button with an additional input function, without on the one hand the movement of the input means being limited so as to be insufficient, and on the other hand with an option being offered to the operator of making a movement available that is easily recognized by touch.

In one embodiment, the control element is provided with a rotationally symmetrical control button which is rotatable about its central axis, which at the same time is its axis of rotation, and pressable. Moreover, a control button constructed according to the invention comprises an integrated horizontal bearing so that the control button can be shifted in any direction in this horizontal plane. In this case, the horizontal plane is defined such that it is a plane perpendicular to the central axis, the plane being substantially horizontally disposed relative to the control button. In most cases in which such a control element is disposed in a motor vehicle and in the center console of the motor vehicle, this horizontal plane corresponds to a horizontal plane through the motor vehicle relative to the underground of the motor vehicle.

In a preferred embodiment of the invention, the horizontal shifting movement is converted in the control element into a tilting movement. In this case, the conversion of the shifting movement into the tilting movement means that mechanical means are available which on the one hand execute a horizontal movement in the control button, which is then converted into a tilting movement in the interior of the control element, mostly in the interior of a housing of the control element, by means of the mechanical means. Usually, the control button has a housing, in which, on the one hand, the mechanical means are mounted, fixed or disposed so as to be movable relative to one another, so that a magnetic, optical, optoelectronic, optoelectric or mechanical detection of the movement of the control button is converted into an electric switching and/or regulating signal. The appropriate means are sufficiently known from the prior art and will not be explained here in more detail (here, a reference to a known patent specification would be helpful). Cardan joints are known for transmitting movements. Cardan joints make it possible to redirect movements, or rather, forces, or more precisely, torques. The invention makes use of the cardan principle and utilizes a cardan element for converting the shifting movement into a tilting movement.

The cardan joint is mounted in the control button in an upper bearing axis and in the housing in a lower bearing axis, in each case in one cardan half shell, and is fixed in each bearing shell with one driving lug, respectively. Here, the mechanical means for transmitting the shifting movement into a tilting movement is generally called a cardan joint. The control button is fixedly mounted in a horizontal plane, so that the shifting movement in any direction according to the invention can be executed in this horizontal plane. It must be noted here that it is described according to the invention that the control button can be shifted into any direction. However, this implies at the same time that it is of course possible for the person skilled in the art to limit, by guides to be inserted, the movements such that the rotary button can only be shifted in, for example, two directions. The cardan joint is displaced in a horizontal direction by a shifting movement of the rotary button. This shifting movement causes the cardan joint to be displaced from its central axis via the driving lug. As a matter of principle, it is assumed in this case that it is a symmetrical rotary button, and that the cardan joint is disposed in the central axis of the rotary button. The horizontal displacement of the driving lug in the upper bearing axis causes the lower half of the cardan joint in the lower cardan half shell to be tilted in the housing of the control element. For example, a known optoelectric evaluation method for the tilting movement is disposed on the cardan joint, so that an evaluation of the shifting movement can be detected as a tilting movement.

The upper bearing shell is inserted into the upper shifting part of the rotary button. The detection of the shifting movement is thereby facilitated because the path of the displacement of the upper bearing shell corresponds to the path of the displacement of the control button of the control element.

### BRIEF DESCRIPTION OF THE DRAWINGS

The cardan joint is preferably manufactured from plastic. Depending on the constructional circumstances, the cardan joint is made in one or several parts. Central lugs made from plastic or from metallic materials are inserted into the ends of the cardan joint, into the upper bearing axis for the upper cardan half shell. This applies analogously for the lower bearing axis and the lower cardan half shell, respectively, and the corresponding driving lug.

The invention is explained in more detail below with reference to an exemplary embodiment. In the drawings:

FIG. 1 shows a control element equipped according to the invention in a lateral section, and

FIG. 2 also shows a lateral section through the control element according to the invention in a view shifted by 90°.

### DETAILED DESCRIPTION

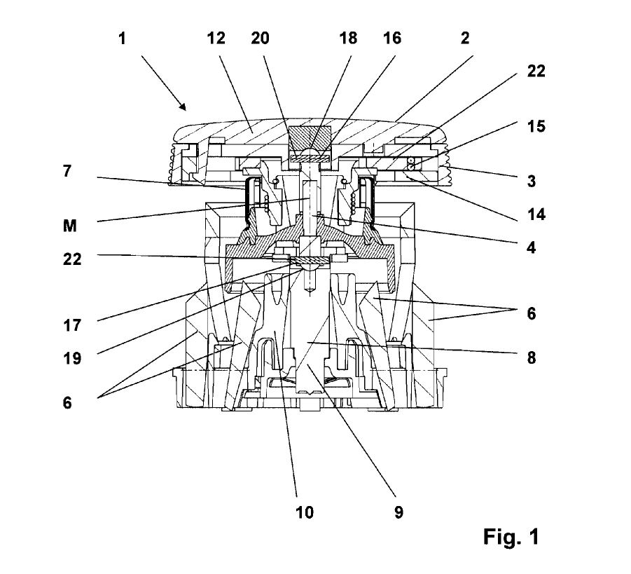

FIG. 1 shows a section through a control element 1 constructed according to the invention in a lateral view. A control button 2 comprising an aluminum ring 3 is retained on the control element 1 so as to be shiftable in the direction of the arrow P. In the case of a shifting movement of the control button 2 in the direction of the arrow P, the central cardan element 4 is tilted, whereby a pot-like baffle 5 is tilted at the same time, which in turn extends between light guiding elements 6, with the light guiding elements 6 serving for the optoelectronic evaluation of the tilting movement. The feel of the tilting movement is realized by means of a detent spring pot 7 acting on the baffle 5 in an annular manner, so that the tilting directions are not limited. However, at the same time this implies that arbitrary shifting directions can also be evaluated.

In addition to the shifting movement of the control button 2, by means of which any direction can be selected and activated, the control button 2 is mounted rotatably about its central axis M. In this case, the cardan element 4 serves the purpose of transmitting the rotary movement from the control button 2 onto the evaluation device 8 of the control element 1. In this case, the evaluation device 8 includes the extension 9 to which a substantially cylindrical switching means 10 is non-rotatably attached, which evaluates a rotational movement of the control button 2 by means of electrical or optoelectronic means.

In addition, the control element, or rather the control button 2, can be pressed in the direction of the arrow P.

The control button 2 can be shifted in any direction in the direction of the arrow P via a link mechanism 11 held in position in the control element 1. In this case, the link mechanism 11 is disposed in a plane which is substantially horizontal and stands perpendicularly on the central axis M. Thus, the control button 2 forms a shifting element 2 including a cover 12, the ring element 3, the disc element 13, the spacer 14 is or can be a part of the disc element 13. The shifting element 2 can be horizontally displaced via the link mechanism 11 over balls 15. The cardan element 4 is mounted in an upper bearing axis 16 and in a lower bearing axis 17, in each case in a cardan half shell 18, 19, and is fixed in each bearing shell 16, 17 with one driving lug 20, 21, respectively. In this case, the upper part of the cardan joint 4 or cardan element 4 is mounted in the disc 13 and the cover 12.

If the shifting element 2 is now moved in the direction of the arrow P, the cardan half shell 18 moves out of the central axis M, so that the cardan element 4 pivots about the lower cardan half shell 19. This tilting movement is evaluated by means of the pot-like baffle 5.

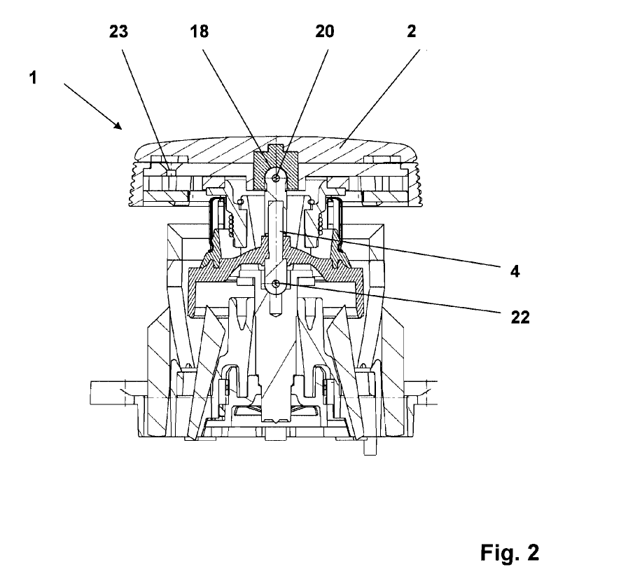

In the link mechanism, for example, three pairs of balls 15 respectively offset by 120° are disposed in the control button 2. The link mechanism 11 equipped with three extensions 22 is inserted into the disc-shaped support 13 and rotated by an angle, so that the balls 15 can be inserted into the apertures 23 in the disc 13 and end up between the guide disc 13 by a rotation of the link mechanism 11. Thus, the link mechanism 11 and the disc 13 form the shifting element 2 for the control element 1, as is shown in more detail in FIG. 2. FIG. 2 also shows a section shifted by 90° through the control element 1 in a lateral view.

1. Control element for a motor vehicle, comprising
a control button retained in the control element so as to be at least rotatable and pressable,
wherein a switching and/or regulating function is assigned to every movement,
wherein the control element can additionally be shifted,
wherein the shifting movement takes place in a plane horizontal relative to the control button.

2. Control button according to patent claim 1, wherein the shifting movement can be converted in the control element into a tilting movement.

3. Control button according to claim 2, wherein the shifting movement can be converted into a tilting movement by means of a cardan joint acting as a cardan element.

4. Control button according to claim 3, wherein the cardan joint is mounted in an upper bearing axis and in a lower bearing axis, in each case in a cardan half shell, and is fixed in each bearing shell with one driving lug, respectively.

5. Control button according to patent claim 4, wherein the upper bearing shell is incorporated in the upper rotary button/shifting part.

6. Control element according to claim 3, wherein the cardan joint is made of plastics and of one or several parts.

7. Control element according to claim 1, wherein the control element is a multifunctional input button for a motor vehicle.
